(19) United States
(12) Patent Application Publication
(10) Pub. No.: US 2015/0056327 A1
(43) Pub. Date: Feb. 26, 2015

(54) CORN MEAL COMPOSITIONS AND METHODS OF PRODUCTION

(71) Applicant: POET Research Inc., Sioux Falls, SD (US)

(72) Inventor: Steven G. Redford, Brandon, SD (US)

(73) Assignee: POET RESEARCH INC., Sioux Falls, SD (US)

(21) Appl. No.: 14/380,162

(22) PCT Filed: Feb. 21, 2013
(86) PCT No.: PCT/US13/27137

§ 371 Date: Aug. 21, 2014

Related U.S. Application Data
(60) Provisional application No. 61/601,655, filed on Feb. 22, 2012.

(51) Int. Cl. A23L 1/10; C12F 3/06; A23J 1/14; A23L 1/105; A23J 1/12

(52) U.S. Cl. CPC A23L 1/1041; A23L 1/105; A23J 1/12; A23J 1/14; C12F 3/06; A23V 2002/00
USPC 426/11; 426/622; 426/425

(57) ABSTRACT

Compositions derived from grain-to-ethanol fermentation processes and methods of producing the compositions are provided. The compositions may be corn meal products generated by fractionating corn kernels to isolate the endosperm, converting starch in the endosperm to sugar at temperatures less than 150-180° F., fermenting the sugar, and separating out the resulting solids. The solids may undergo a protein extraction process, and then undergo a solvent exchange to remove water from the solids and re-place it with a more volatile chemical, such as ethanol. The solids are then dried at less than 150-180° F. The resulting meal product may include protein in an amount ranging from about 31 to about 45%, up to about 3% fat, up to about 3% ash, a neutral detergent fiber in an amount ranging from about 32 to about 50%, and up to about 15% starch, all on a dry weight basis.

### CROSS-REFERENCE TO RELATED APPLICATIONS

This application claims benefit of priority to U.S. Provisional Patent Application No. 61/601,655, entitled, “CORN MEAL COMPOSITIONS AND METHODS OF PRODUCTION,” filed Feb. 22, 2012, which application is incorporated herein by reference in its entirety.

### FIELD

The present disclosure relates to unique corn meal compositions generated through the manufacture of ethanol.

### BACKGROUND

The present disclosure relates to compositions of a unique corn meal that is manufactured as a co-product of a low energy process of producing ethanol. Ethanol traditionally has been produced from grain-based feedstocks (e.g., corn, sorghum/milo, barley, wheat, soybeans, etc.), or from sugar (e.g., sugar cane, sugar beets, etc.). In addition to the manufacture of the alcohol from the carbohydrate materials of the feedstock, a number of co-products are generated that are additional sources of revenue for the manufacturer. These co-products include carbon dioxide gas for the industrial and food industries, as well as protein rich animal feed products.

In a conventional ethanol plant, corn, sugar cane, other grain, beets or other plants are used as a feedstock and ethanol is produced from starch contained within the corn, or other plant feedstock. In the case of a corn facility, corn kernels are cleaned and milled to prepare starch-containing material for processing. Corn kernels can also be fractionated to separate the starch-containing material (e.g., endosperm) from other matter (such as fiber and germ). Initial treatment of the feedstock varies by feedstock type. Generally, however, the starch and sugar contained in the plant material is extracted using a combination of mechanical and chemical means.

The starch-containing material is slurried with water and liquefied to facilitate saccharification, where the starch is converted into sugar (e.g., glucose), and fermentation, where the sugar is converted by an ethanologen (e.g., yeast) into ethanol. The fermentation product is beer, which comprises a liquid component, including ethanol, water, and soluble components, and a solids component, including unfermented particulate matter (among other things).

In a traditional plant, the fermentation product is sent to a distillation system where the fermentation product is distilled and dehydrated into ethanol. The residual matter (e.g., whole stillage) can be dried into dried distillers grains (DDG) and sold, for example, as an animal feed product.

However, the distillation of the fermentation product and drying of the DDG product is costly due to the large amount of energy required to evaporate large volumes of water. In addition, as much of the energy for drying comes from fossil fuel sources, pollution is also an issue in the manufacture of the DDG product. This is due to the high boiling point, high heat capacity, and high heat of vaporization for water. When the DDGs are being dried, excess water is essentially evaporated off. This requires a vacuum and/or a large amount of heat to accomplish effectively. Additionally, the solids are required to pass through distillation, adding to the volume of material requiring heating to the vaporization temperature of ethanol.

In order to reduce the heat energy needed to dry a mixture of solids and water, water may be replaced with a fluid having boiling point, heat capacity or heat of vaporization properties that are lower than water. Illustratively, a fluid such as ethanol, which has a lower boiling point, heat capacity, and heat of vaporization when compared to water, could be used. Because of its physical properties, drying a mixture of solids and ethanol requires lower amounts of heat energy than drying a mixture of solids and water. Completely displacing the water in the mixture of solids and water is not necessary to realize a decrease in energy usage, however. Water in the mixture of solids and water may be supplemented with a quantity of ethanol in order to reduce the overall heat of vaporization of the mixture, thereby reducing the amount of energy needed to dry the mixture while lowering the boiling point.

Given these principles, methods of producing ethanol using reduced energy have been designed and tested. Examples of such systems are disclosed in U.S. patent application Ser. No. 12/646,746 entitled “System for Production of Ethanol and Co-Products with Apparatus for Solvent Washing of Fermentation Product” filed Dec. 23, 2009, which is incorporated in its entirety for reference.

In addition to lowering energy requirements for the production of the ethanol, the co-products generated through said processes have unique properties not seen in conventional ethanol production co-products. In addition, the properties of these co-products can be further modified through process conditions to yield favorable products.

Given the need to generate commercialize-able co-products in the ethanol industry, and the continuing need in the marketplace for reliable and consistent animal feed, compositions of a novel corn meal are provided. The disclosed corn meal, and methods of manufacture, results in a meal product that is has been subjected to much lower temperatures throughout its production, as compared to traditional ethanol plant co-product feeds.

### SUMMARY

The disclosed embodiments relate to compositions and methods of generating a grain-based fermentation-derived product, such as a corn meal product. This grain-based product can be manufactured at a low energy ethanol production facility as a co-product to the fermentation of grain-based materials, such as corn materials. As product is not subjected to as high temperatures as compared to traditional distillers grains, the nutritional profile and protein structure are unique.

Corn meal products may be generated by fractionating corn kernels to isolate the endosperm (starch-rich portion). The endosperm is milled and subjected to a “cold cook” conversion of the starch to sugar using enzymes. The cold cook occurs at temperatures ranging from about 150-180° F. or less. The resulting slurry is fermented utilizing yeast to generate ethanol (or other desired fermentation product such as butanol, etc.).

The resulting fermentation product includes a slurry of solids and liquids, which can be separated. The liquids may be passed along to distillation, while the solids may undergo a protein extraction process, which may alter the downstream properties of the corn meal product, increase processing efficiency, and/or the extracted protein may be sold as a valuable co-product.

The resulting wet solids then undergo a solvent exchange to remove water from the solids and replace it with a more volatile chemical, such as ethanol. The solids are then dried. Since a volatile chemical is now in the solids, this drying step may be performed at a much lower temperature, on the order of about 150-180° F. or less. Starch may be removed from the meal product or solids in some cases.

The resulting meal product has never experienced temperatures above 150-180° F., and as such are expected to have minimal protein or starch damage as compared to higher temperature processes. Color may also be improved. In some embodiments, the resulting product, for example the resulting corn meal product, may include protein in an amount ranging from about 31 to about 45% protein, up to about 3% fat, up to about 3% ash, a neutral detergent fiber in an amount ranging fraom about 32 to about 50%, and up to about 15% starch, all on a dry weight basis.

In some embodiments, the compositions include a product derived from a wet solids portion of a beer product of a grain-to-ethanol fermentation process, wherein the product comprises a minimally heat-damaged protein in an amount ranging from about 31% to about 45% of the product on a dry weight basis, and wherein the minimally heat-damaged protein is a protein that has not been exposed to temperatures exceeding about 180 degrees F. In some embodiments, the product is as corn meal product, and the grain is corn. In some embodiments, the protein has not been exposed to temperatures exceeding about 150 degrees F. In some embodiments, the product further comprises fat in an amount ranging up to about 3% on a dry weight basis. In some embdoiments, the product comprises fat in an amount ranging from about 0.8 to about 3%, or from about 0.9 to about 3% on a dry weight basis. In some embodiments, the product further comprises up to about 3% fat on a dry weight basis. In some embodiments the product further comprises fat in an amount ranging from about 0.9 to about 2.7%, from about 1.2 to about 2.5% on a dry weight basis. In some embodiments, the product further comprises a neutral detergent fiber in an amount ranging from about 32 to about 50% on a dry weight basis, or from about 32 to about 48% on a dry weight basis. In some embodiments, the product further comprises starch in an amount up to about 15% on a dry weight basis, or in an amount ranging from about 10 to about 15% on a dry weight basis. In some embodiments the product further comprises one or more of fat, ash, a neutral detergent fiber, and starch in the above-referenced amounts. In some embodiments, the grain is soybean.

In some embodiments, the process involves exchanging at least a portion of the water in a wet solids product derived from a grain-to-ethanol fermentation beer with a solvent having at least one of a lower heat of vaporization, a lower heat capacity, or a lower boiling point than water; and, drying the wet solids at a temperature of about 180 degrees or less to generate a product, such as a corn meal product. In some embodiments, the process also includes fractionating a corn kernel to substantially isolate an endosperm, converting at least some portion of starch in the endosperm to sugar at a temperature of about 180 degrees F. or less, fermenting the sugar to produce a beer, and obtaining the wet solids product from the beer. In some embodiments, the process also involves extracting a protein from the wet solids prior to the solvent exchange. In some embodiments, the process involves removing some or all of the starch from the solids. In some embodiments, drying is performed at a temperature of about 150 degrees F. or less. In some embodiments the solvent is ethanol. In some embodiments, the solvent is an ethanol and water solution. In some embodiments, the solvent exchange results in a concentration of ethanol in the wet solids at or above the azeotrope point of water in ethanol.

Note that the various features of the present disclosure described above may be practiced alone or in combination. These and other features of the present disclosure will be described in more detail below in the detailed description of the disclosure and in conjunction with the following figures.

### DESCRIPTION OF THE DRAWINGS

Some non-limiting embodiments in accordance with the disclosure will now be described, by way of example, with reference to the accompanying drawings, in which:

FIG. 1 is a perspective view of a biorefinery comprising an ethanol production facility, in accordance with some embodiments.

FIGS. 2A and 2B are an example process flow diagram illustrating the steps used to generate ethanol in a cold-cook ethanol production facility, in accordance with some embodiments.

FIG. 3 is an example process flow diagram illustrating the steps used to generate ethanol and co-products in a low energy cold-cook ethanol production facility, in accordance with some embodiments.

FIG. 4 is an example schematic block flow diagram illustrating particular steps used to generate ethanol and co-products in a low energy cold-cook ethanol production facility, in accordance with some embodiments.

FIG. 5 is a second example schematic block flow diagram illustrating steps used to generate ethanol and co-products in a low energy cold-cook ethanol production facility, in accordance with some embodiments.

FIG. 6 is a chart conceptually illustrating the energy required to dry wet solids depending on the concentration of ethanol in the solids.

FIGS. 7A to 7E are cross sectional schematic illustrations detailing a filter belt embodiment of the solvent exchange used in the low energy generation of ethanol and co-products, in accordance with some embodiments.

FIG. 8 is an isometric schematic illustrating the filter belt embodiment of the solvent exchange used in the low energy generation of ethanol and co-products, in accordance with some embodiments.

FIG. 9 is a side cross sectional schematic illustrating the filter belt embodiment of the solvent exchange used in the low energy generation of ethanol and co-products, in accordance with some embodiments.

Table 1 provides compositional ranges for an example corn meal product on a dry weight basis.

Table 2 provides compositional ranges for an example corn meal product with starch removed on a dry weight basis.

Table 3 provides compositional ranges for an example corn meal product, with altered upstream protein removal processes, on a dry weight basis.

### DETAILED DESCRIPTION

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

The word “exemplary” is used to mean serving as an example, instance, or illustration. Any embodiment or design described as “exemplary” is not necessarily to be construed as preferred or advantageous over other embodiments or designs, nor is it meant to preclude equivalent exemplary structures and techniques known to those of ordinary skill in the art. Rather, use of the word exemplary is intended to present concepts in a concrete fashion, and the disclosed subject matter is not limited by such examples.

The term “or” is intended to mean an inclusive “or” rather than an exclusive “or.” To the extent that the terms “comprises,” “has,” “contains,” and other similar words are used in either the detailed description or the claims, for the avoidance of doubt, such terms are intended to be inclusive in a manner similar to the term “comprising” as an open transition word without precluding any additional or other elements.

Where ever the phrases “for example,” “such as,” “including” and the like are used herein, the phrase “and without limitation” is understood to follow unless explicitly stated otherwise.

Whenever the phrase “derived from” or the like is used, “directly or indirectly” is understood to follow. The words “a,” “an,” “the,” and “said” when used in the claims mean “one or more” unless explicitly stated otherwise.

The term “substantially” (or alternatively “effectively”) is meant to permit deviations from the descriptive term that don't negatively impact the intended purpose and/or deviations from the descriptive term taking into account inherent technological limitations. Descriptive terms are implicitly understood to be modified by the word substantially, even if the term is not explicitly modified by the word substantially.

The term “about” is meant to account for variations due to experimental error or deviations that don't negatively impact the intended purpose. All measurements or numbers are implicitly understood to be modified by the word about, even if the measurement or number is not explicitly modified by the word about.

A “minimally heat-damaged protein” is protein that has not been exposed to temperatures exceeding about 180° F.

Compositions and methods in accordance with this disclosure will now be described in detail with reference to several embodiments thereof as illustrated in the accompanying drawings. In the following description, numerous specific details are set forth in order to provide a thorough understanding of embodiments of the present disclosure. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present disclosure relates to the manufacture and compositions of unique corn meal products through the low energy production of ethanol from a corn feedstock. This corn meal has applications as an animal feed, industrial uses, polarization binder, filler product and fertilizer, to name a few. Corn meal generated through ethanol production in this manner is unique as compared to traditional Dried Distillers Grains (DDG) and DDG with soluble (DDGS) due to the consistently low processing temperature. Without being bound by theory, it is believed this prevents any substantial gelatinization of starch, and protein damage in the corn meal product that provides a unique nutritional profile compared to known DDG, DDGS and ground corn flours.

Note that the following disclosure includes a series of subsections. These subsections are not intended to limit the scope of the disclosure in any way, and are merely for the sake of clarity and ease of reading. As such, disclosure in one section may be equally applied to processes or descriptions of another section if and where applicable. Also note, that while particular consideration is made to the use of corn kernels as the starting feedstock, other materials may be substituted in particular embodiments. For example, soybean, or a combination of grains, may be utilized in some cases to generate ethanol and co-products under low energy conditions. This may result in other novel compositions that are considered within the scope of the present disclosure.

I. Cold Cook Ethanol Production

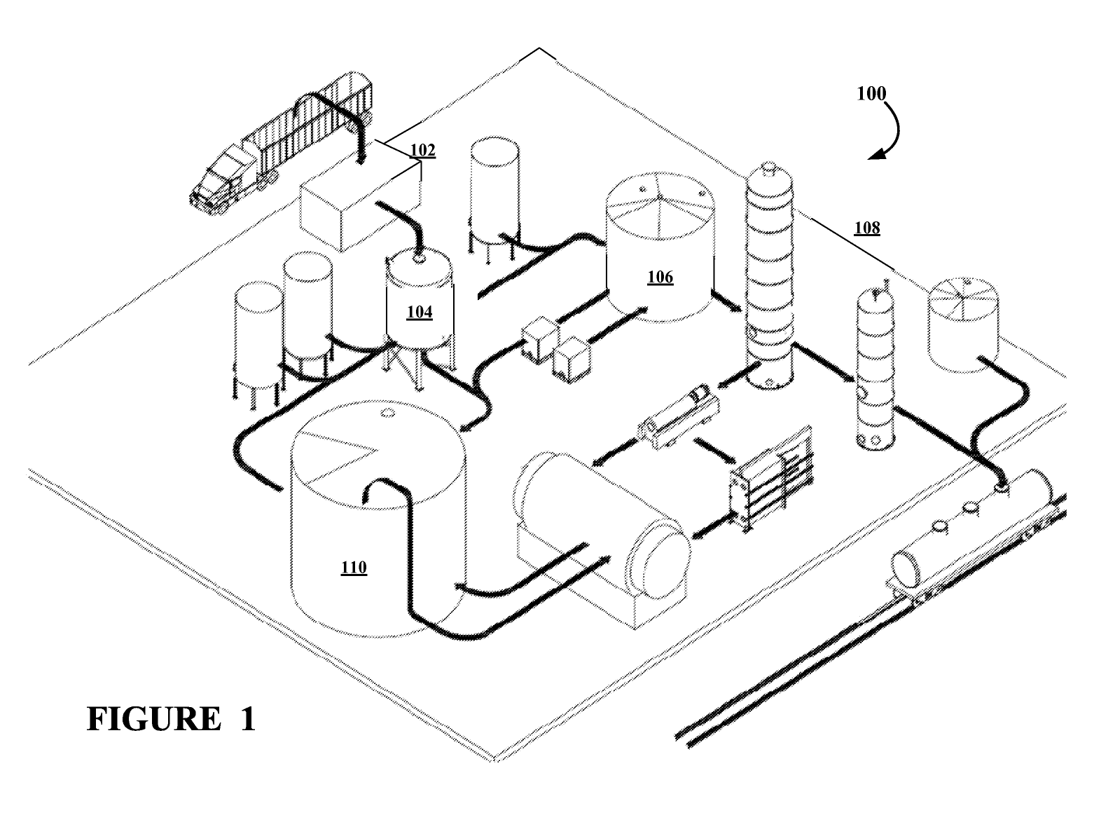

In order to facilitate disclosure, FIG. 1 is a perspective view of an example biorefinery 100 comprising an ethanol production facility configured to produce ethanol from corn. The example biorefinery 100 comprises an area 102 where corn (or other suitable material including, but not limited to, biomass, sugars, and other starch products) is delivered and prepared to be supplied to the ethanol production facility. The ethanol production facility comprises apparatus 104 for preparation and treatment (e.g., milling) of the corn into corn flour suitable for fermentation into fermentation product in a fermentation system 106. The ethanol production facility comprises a distillation system 108 in which the fermentation product is distilled and dehydrated into ethanol. The biorefinery may also comprise, in some embodiments, a by-product treatment system (shown as comprising a centrifuge, a dryer, and an evaporator).

In some embodiments, the biorefinery may be referred to as a “fractionation” ethanol production facility, where the corn kernel, prior to milling, is fractionated into its three component parts. These include the outer shell (corn bran) which is predominantly a fiber material, the starch-filled endosperm, and a protein-rich germ portion. The benefit of fractionation is that the low starch components can be syphoned into different process streams, thereby ensuring that only the high-starch endosperm undergoes liquefaction, fermentation and distillation. This ensures operation that is more efficient, lower yeast and enzyme requirements, and lower energy expended per gallon of ethanol produced. Lastly, the corn bran and germ fractions may be sold as additional co products for the feed industry, or may be further processed to generate higher value co-products.

While much of the discussion below will center around a fractionation style biorefinery, it is considered within the scope of the present disclosure that whole kernel plants may also be employed for the generation of corn meal, as will be described in further detail below. Additionally, as previously noted, any of the disclosed ethanol production facilities may include modifications for the processing of other feedstocks instead, or in addition to, corn kernels.

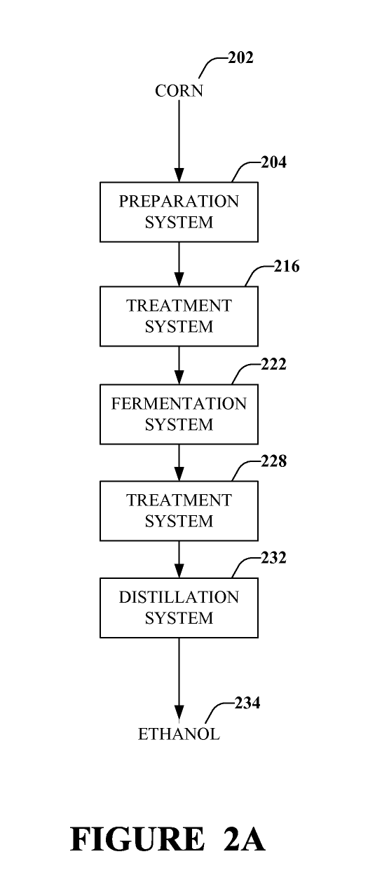

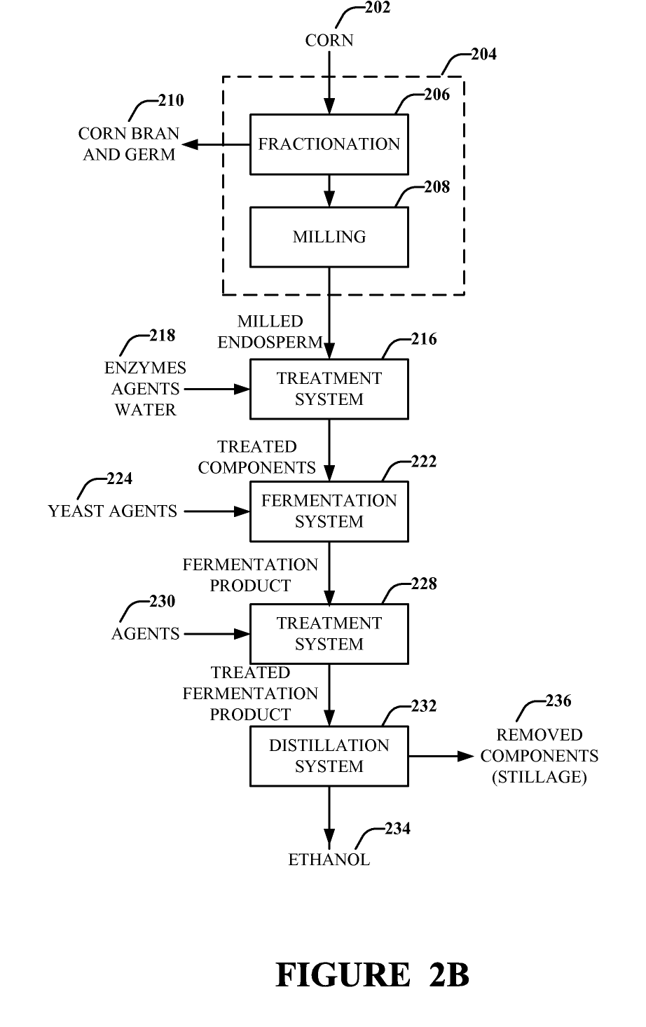

FIGS. 2A and 2B are an example process flow diagram illustrating the steps used to generate ethanol in a cold-cook ethanol production facility, in accordance with some embodiments. In an ethanol production process, corn 202 (or other suitable feed material) may be prepared for further treatment in a preparation system 204. As seen in FIG. 2B, the preparation system 204 may comprise a fractionation system 206 to fractionate the corn kernel into its three constituents, as described above. Fractionation may employ mills, size exclusion and density separation in order to be effectual. The bran and germ components 210 are removed for further processing or sale as raw materials. In some cases, a screening process may be performed prior or post fractionation that removes foreign material, such as rocks, dirt, sand, pieces of corn cobs and stalk, and other unfermentable material (e.g., removed components).

After fractionation, the particle size of the endosperm may be reduced by milling 208 to facilitate further processing. The milled corn is slurried with water, enzymes and agents 218 to facilitate the conversion of starch into sugar (e.g. glucose), such as in a first treatment system 216. In “conventional” corn-to-ethanol facilities, the flour slurry is heated in a jet cooker in order to convert the starch into sugar. By using an enzymatic approach, without any external heating, a “cold cook” process is achieved. Cold cooking benefits from a reduction in energy required, reduced overall costs, and minimal heat damage to the starch and proteins of the endosperm flour. Of course the generation of corn meal could be done using a conventional process involving a high heat cooking; however, this may alter the protein profile found in cold cook corn meal due to heat damage.

The sugar (e.g., treated component) is converted into ethanol by an ethanologen (e.g. yeast or other agents 224) in a fermentation system 222. The product of fermentation (fermentation product) is beer, which comprises a liquid component, including ethanol and water and soluble components, and a solids component, including unfermented particulate matter (among other things). The fermentation product may be treated with agents 230 in a second treatment system 228. At this stage, a low energy facility differs from a standard cold cook facility.

In the illustrated standard facility, the treated fermentation product is sent to a distillation system 232. In the distillation system 232, the (treated) fermentation product is distilled and dehydrated into ethanol 234. In some embodiments, the removed components 236 (e.g., whole stillage), which comprise water, soluble components, oil and unfermented solids (e.g., the solids component of the beer with substantially all ethanol removed), may be dried into dried distillers grains (DDG) in a third treatment system (where the removed components may be treated with agents) and sold as an animal feed product. Other co-products, for example, syrup (and oil contained in the syrup), may also be recovered from the stillage.

Conversely, a “low energy” ethanol production facility avoids distilling the fermentation product, and undergoes a solvent exchange on the solids in order to reduce drying energy. This process is described in greater detail below.

II. Low Energy Ethanol and Co-Product Production

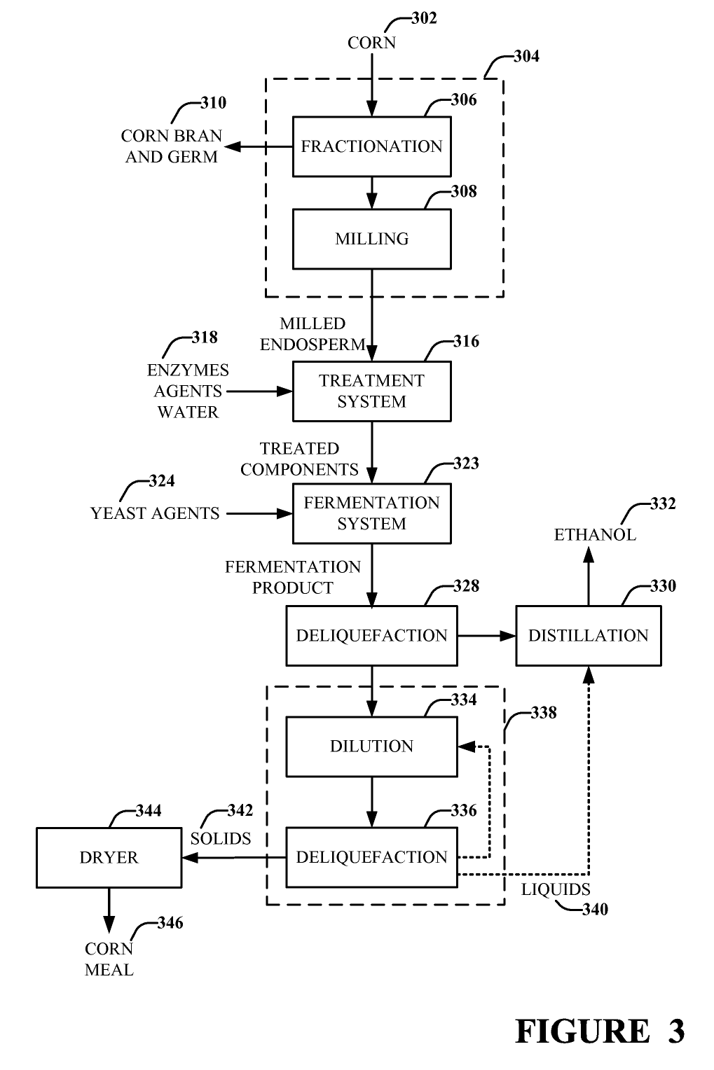

FIG. 3 is an example process flow diagram illustrating the steps used to generate ethanol and co-products in a low energy cold-cook ethanol production facility, in accordance with some embodiments. The initial stages of such a manufacturing process are similar to traditional plants. The incoming corn 302 is fractionated (in a fractionation plant) in the fractionation system 306. The corn bran (fiber) and germ 310 components are removed, and the endosperm is sent to the milling system 308 for size reduction to flour.

The flour/milled endosperm is slurried in a treatment system 316 with water and enzymes 318 to yield sugars. Yeast and other agents are 324 added to a fermentation system 323 in order to convert the sugars to ethanol and carbon dioxide. The carbon dioxide is typically captured and sold for industrial and beverage use.

After fermentation, however, this low energy process deviates significantly from standard ethanol production practices. Water has a very high boiling point, heat capacity, and heat of vaporization. Because of these characteristics, a large amount of energy is required to heat water to a temperature sufficient to vaporize the water and then carry out the vaporization. The disclosed low energy facility is designed to wash or extract water from wet solids using a solvent with a low heat of vaporization, heat capacity, and boiling point, or some combination of these three characteristics. Once some water has been extracted from the wet solids, the wet solids, which now comprise a quantity of the solvent, are dried using lower amounts of energy. Because of the availability of ethanol in an ethanol plant, ethanol is a particularly relevant solvent to be used in the wash, or water extraction, process of the present inventions. Ethanol is known to have a heat capacity of 0.58 Btu/lb-F, which is approximately half of heat capacity of water. The boiling point of ethanol is approximately 173 degrees Fahrenheit versus the boiling point of water, which is approximately 212 degrees Fahrenheit. Finally, the heat of vaporization of ethanol is approximately 362 Btu/lb versus the heat of vaporization of water, which is approximately 980 Btu/lb.

In order to effectuate this washing/solvent exchange, instead of sending the fermentation product to a distillation, it is first deliquefied using a screw press, centrifuge, or membrane (collectively referred to as a deliquefaction system 328). This separates out the water and ethanol portion of the beer, which is sent to a distillation system 330, and leaves a solids component. The concentration of ethanol in wet solids is determined by the fermentation process, but is typically between 11 and 20 percent, although concentrations of amounts lower than this range and higher than this range are compatible with the embodiments disclosed in this application. This range of typical ethanol concentrations of wet solids separated from fermented beer is relatively low compared to the water concentration in the wet solids. Wet solids separated from fermented beer have a relatively high water content and a relatively low ethanol content.

The solids are then provided to one or more solvent exchange cycles 338 where the solids are subjected to a dilution stage 334 followed by a deliquefaction stage 336. It should be noted that literal dilution of the solids is not necessary. A solid may have a volume of liquid washed through it without the concentration of liquid in the solids changing throughout the wash. The solids 342 from this solvent exchange are provided to a dryer 334 to generate the corn meal 346. The solvent exchange replaces the residual water in the solids with a solvent (typically ethanol) with a lower heat of vaporization. As such, the dryer may be operated at a much lower temperature as compared to dryers that are utilized in standard plants. In some embodiments, the dryers 344 operate at or below roughly 150° F.

Returning to the solvent exchange cycle 338, the liquids 340 removed from any one deliquefaction stage 336 may be recycled to any of a previous dilution stage 334, or may be sent to the distillation system 330 for recovery of ethanol 332. By directing only the fermented liquid mixture to the distillation system, the distillation system is less susceptible to fouling, which is primarily caused by solids present when fermented beer is distilled directly. With a reduced susceptibility to fouling, complicated anti-fouling provisions of the distillation system may be unnecessary, thereby reducing the complexity and cost of the distillation system. Because the fermented liquid mixture processed by the distillation system is substantially free of solid components, heat energy applied to the distillation system will only have to heat those minimal solids dissolved in or otherwise present in the fermented liquid mixture. This reduces distillation system heat energy requirements compared to a distillation system that must heat both the solid and liquid components of fermented beer.

In some specific embodiments, only one cycle of dilution and deliquefaction is performed. In alternate embodiments, it may be desirable to undergo multiple dilutions and deliquefaction steps in order to replace as much of the water in the solids with ethanol (or other solvent) as economically possible. In these multiple solvent exchange cycles, the liquid from a later stage may be recycled as the dilution liquid for the previous cycle in a counter-current methodology in order to more efficiently replace the water with solvent.

Additionally, in some embodiments, it is desirable to remove some protein fractions prior to the solvent exchange. In these embodiments, during the first dilution, a specific solvent type and concentration may be employed to solubilize desired proteins. These proteins may then be recovered from the solvent by changing concentration or temperature. One such protein in corn that may be removed is zein. Although zein is a protein, many animals do not easily digest it, and the corn meal generated can benefit from its removal. Further, zein has a number of industrial and human consumption end uses that make it a valuable co-product in its own right.

Zein is soluble at particular temperatures and concentrations of an ethanol and water solution, as is well known in the art. By managing the solvent ethanol concentration, temperature, added agents, and retention time, particular protein fractions and concentrations may be removed prior to the full solvent exchange. As such, the eventual corn meal generated may have the protein profile, and compositional makeup, tailored by upstream protein extractions.

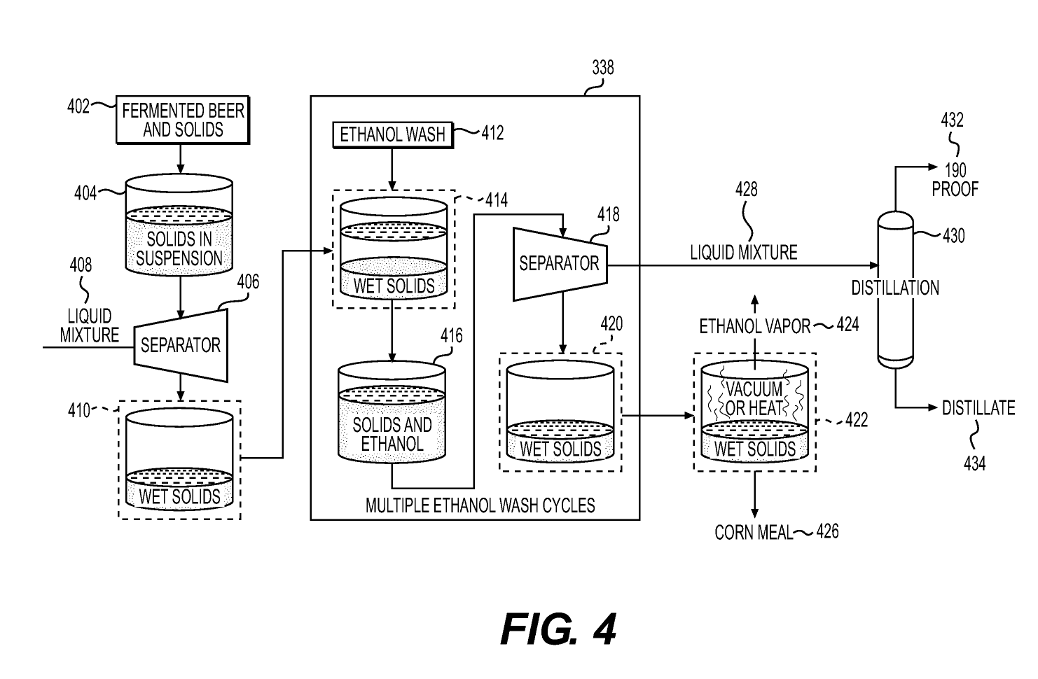

FIG. 4 is an example schematic block flow diagram illustrating particular steps used to generate ethanol and co-products in a low energy cold-cook ethanol production facility, in accordance with some embodiments. This system illustrates the fermentation product 402 in a suspension 404 which is subjected to a first deliquefaction separation 406. The liquid mixture 408 may be supplied to a distillation system to recover the ethanol. The remaining wet solids 410 include a low concentration of ethanol. Ethanol wash liquid 412 may be added at to the solids wash stage 414 and substantially mixed/washed 416 prior to another separation 418. The liquids 428 of this separation may be provided to a distillation system 430. The resulting wet solids 420 may be sent to an evaporator 422, or may be subjected to a series of additional wash stages. Ethanol vapor 424 from the drying solids is collected and recycled to the wash, or supplied to the distillation system. Corn meal 426 is generated from this process. Additionally 190 proof ethanol 432 and distillate 434 are likewise generated.

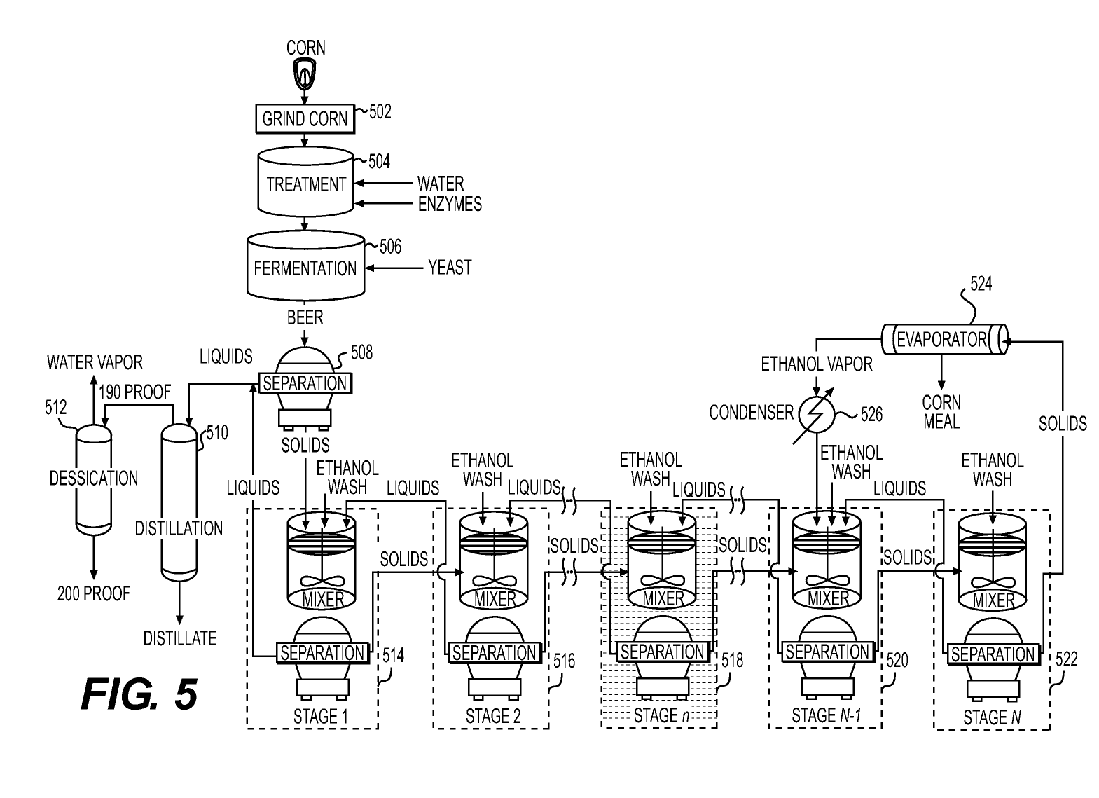

FIG. 5 provides a second example schematic block flow diagram illustrating steps used to generate ethanol and co-products in a low energy cold-cook ethanol production facility, in accordance with some embodiments. Similar processes occur in this system. The corn is ground (or fractionated and the endosperm is ground) at the grinder 502, and treated with enzymes to generate sugar in a treatment system 504. The slurry is fermented in the fermentation system 506, and the beer product is separated in a separator 508 into solids and liquids. The liquids go to the distillation system 510 and a desiccation system 512 to generate pure ethanol.

The solids are provided to a first wash stage 514, where wash liquid from the following stage is cycled back as the wash fluid. Additional ethanol may be provided in order to separate out protein, like zein, as desired. The diluted solids are separated, and the liquids are sent to the distillation system 510. The solids then progress to a second wash stage 516. Wash fluid for the second wash stage 516 are received from the previous stage in a countercurrent fashion. The separated liquid at the end of this stage are provided back to the first initial wash/protein extraction step.

The solids may then undergo any number of additional washes at one or more wash stages 518. Each stage receives the wash fluid from the stage immediately thereafter. The solids then enter a second to laststage (stage N-1) 520. This stage receives wash fluid from the final stage (stage N) 520. Any stages may also have additional ethanol added to the wash stages. The final stage 520 is supplied with a highly concentrated ethanol wash to ensure substantially all water has been removed from the solids. The solids then are provided to the evaporator/dryer to yield the corn meal. If a large number of ethanol wash stages are used, the composition of the resulting wet solids will have a concentration of ethanol close to that of the concentration of ethanol in the original ethanol wash supplied to the final ethanol wash stage (Stage N). Any number of ethanol wash cycles may be inserted as Stage n. Any concentration of ethanol and water may be used as an ethanol wash in Stage n.

In a scenario employing a large number of ethanol wash stages, a minimum amount of fresh ethanol wash would need to be added in the final wash stage to produce resulting wet solids having a desired concentration of ethanol. By using a small amount of ethanol wash, only a small amount of the fluid from the deliquefaction stage of the initial ethanol wash cycle (Stage 1) would require distillation, thereby reducing the energy used by the distillation stage. The distillation of fluid from the deliquefaction stage is an energy requirement not present in a conventional ethanol plan, and minimization of this energy requirement is desirable.

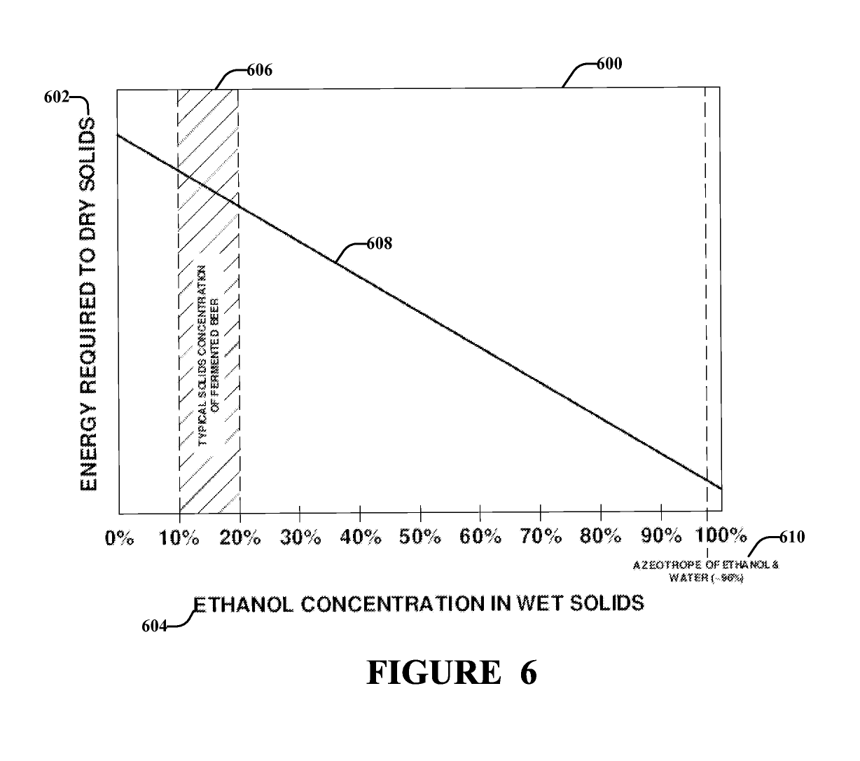

FIG. 6 is a simplified chart conceptually illustrating the energy required to dry wet solids depending on the concentration of ethanol in the solids. By increasing the ethanol concentration in the wet solids (as shown on the horizontal axis 604), the amount of energy required to dry the solids (as shown on the vertical axis 602) is reduced (shown as plotted line 608). Typically, the solids generated by fermentation have an ethanol concentration of about 10-20% (as shown at 606).

The azeotrope point of water and ethanol is indicated on the chart (at 610). In order to achieve a concentration of ethanol in the wet solids at or above the azeotrope point of water and ethanol, a concentration of ethanol at a ratio at or above the azeotrope point of water and ethanol must be used in the wash cycle. Because anhydrous ethanol (200 proof, or 100 percent), or substantially anhydrous ethanol, is costly to produce or otherwise procure, it is desirable to minimize its use in the ethanol wash cycle.

In order to achieve a concentration of ethanol in the wet solids at or above the azeotrope point of water and ethanol, a small amount of substantially anhydrous ethanol could be used as a dilutant of wet solids containing liquid at a concentration just below the azeotrope point. In an ethanol plant, one source for ethanol just below azeotropic concentration is at the output of the using ethanol from the distillation system, the wet solids would contain a liquid component with a concentration of water and ethanol no higher than just below the azeotrope point. A final wash cycle may be implemented at this point using a small amount of substantially anhydrous ethanol. The resulting wet solids from this final wash cycle could then contain a liquid component with a concentration of water and ethanol at or above the azeotrope point.

III. Solvent Exchange Utilizing a Filter Belt

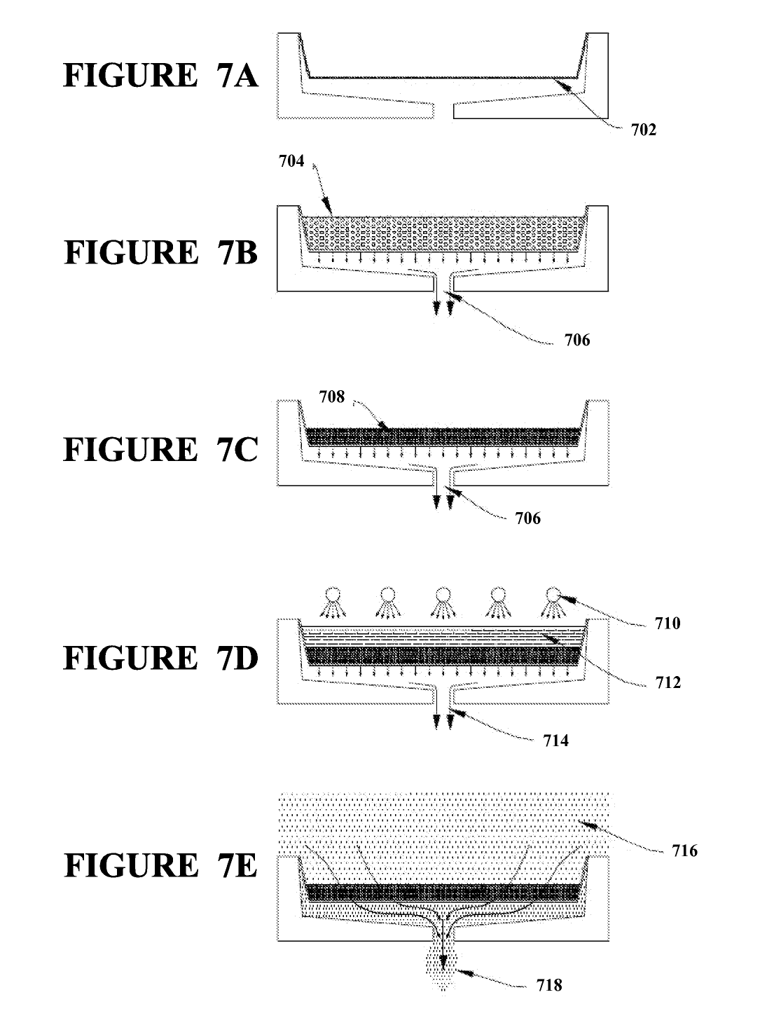

FIGS. 7A to 7E show cross sectional views of a filter belt at various positions along the belt. Although any conventional filter belt technology may be employed, the filter belt 702, as shown in FIG. 7A, may have a substantially perforated or porous structure such that a liquid component of material placed on the filter belt 702 may be drawn through the belt, leaving a solid component of the material placed on the filter belt 702 behind. In FIG. 7B, fermented beer and solids 704 are shown loaded onto the filter belt 702. A vacuum beneath the filter belt draws the mother liquor 706 (liquid component) from the fermented beer and solids through the filter belt, leaving behind wet solids 708, as shown in FIG. 7C. FIGS. 7D illustrates an ethanol wash cycle as implemented using a filter belt, including the steps of diluting wet solids 708 with an ethanol wash 712 to form a mixture and deliquefaction the mixture using a vacuum to produce resultant wet solids having a higher concentration of ethanol than the initial wet solids.

The ethanol wash 712 is shown being applied to the wet solids by spray nozzles 710 above the filter belt. Although spray nozzles 710 are shown, other means of applying an ethanol wash 712 to the wet solids 708 may be employed. The liquid component 714 of the mixture, which is drawn through the belt 702, is collected and may be used as an ethanol wash 710 in another ethanol wash cycle.

FIG. 7E illustrates the evaporation stage implemented using a filter belt in which heated gas 716 is applied to the material above the filter belt. A vacuum beneath the filter belt draws the heated gas 716 through the material above the filter belt. An ethanol vapor 718, which includes liquid collected by the heated gas as it was drawing through the material above the filter belt, may be collected and further processed to recover any ethanol or other desirable component that is present in the ethanol vapor 718.

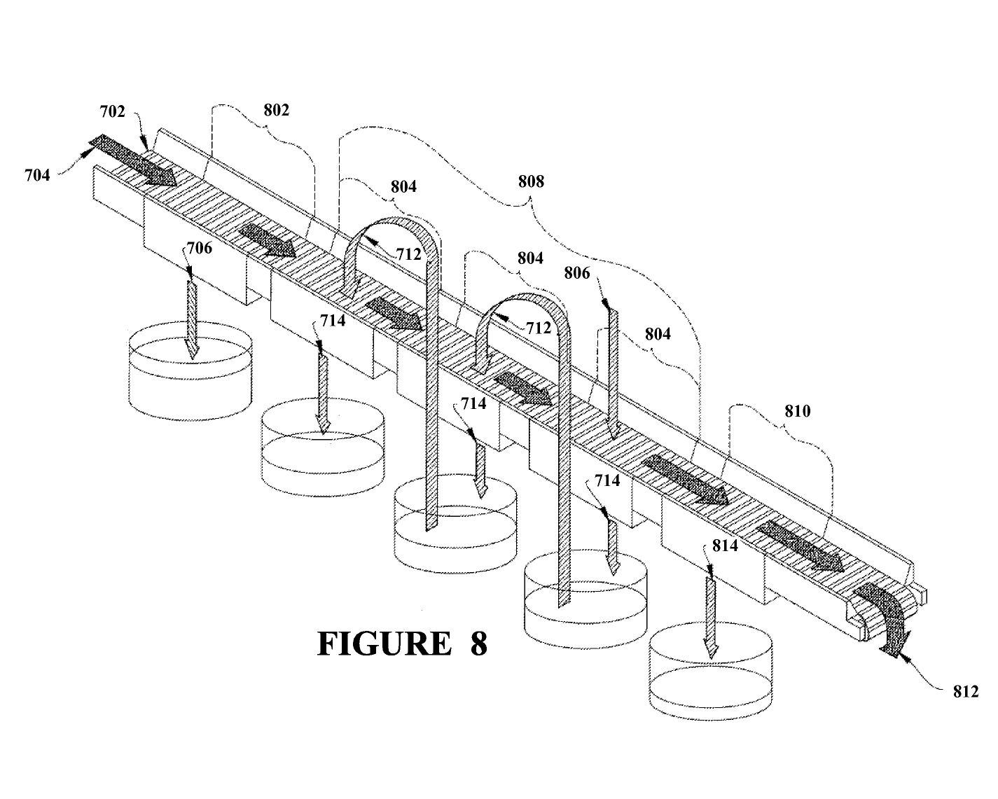

FIG. 8 shows an isometric schematic view of a filter belt implementing a countercurrent wash. Fermented beer and solids 704 are loaded on the filter belt 702, as was first shown in FIG. 7B. Fermented beer and solids 704 travel through an initial deliquefaction stage 802, a series of ethanol wash cycles 808, and an evaporation stage 810, before being output from the opposite end of the filter belt 702 as corn meal 812. The corn meal may not be completely dried and may contain some level of moisture desirable to facilitate materials handling. In the initial deliquefaction stage 802, first shown in FIGS. 7B and 7C, the mother liquor 706 of the fermented beer and solids 704 is drawn through the filter belt 702 by a vacuum beneath the filter belt. The mother liquor 706 may be distilled to isolate ethanol in the mother liquor 706. Ethanol distilled from the mother liquor 706 may be used as an ethanol wash 712 in an ethanol wash cycle. After the mother liquor 706 of the fermented beer and solids 704 is removed, the remaining solid component, which contains some residual liquid, is referred to as wet solids 708.

After the initial deliquefaction stage 802, the wet solids 708 are conveyed to a series of ethanol wash cycles 808. In an embodiment, each individual wash cycle 804 uses as its ethanol wash 712 the liquid component 714 from the following stage. The initial ethanol wash 806 is applied to the wet solids 708 just prior to the evaporation stage, at a downstream ethanol wash cycle 804. This initial ethanol wash 806 is applied to the wet solids 708 to form a mixture. The liquid component 714 of that mixture is drawn through the filter belt 702 by a vacuum beneath the filter belt and subsequently collected. In some embodiments, the liquid component 714 is used as the ethanol wash 712 of an upstream ethanol wash stage 804. The use of the liquid component 714 from a downstream ethanol wash stage 804 as the ethanol wash 712 of an upstream ethanol wash stage 804 is referred to as countercurrent washing, as the flow of wet solids on the filter belt is in a direction opposite the flow of the liquid being used as an ethanol wash.

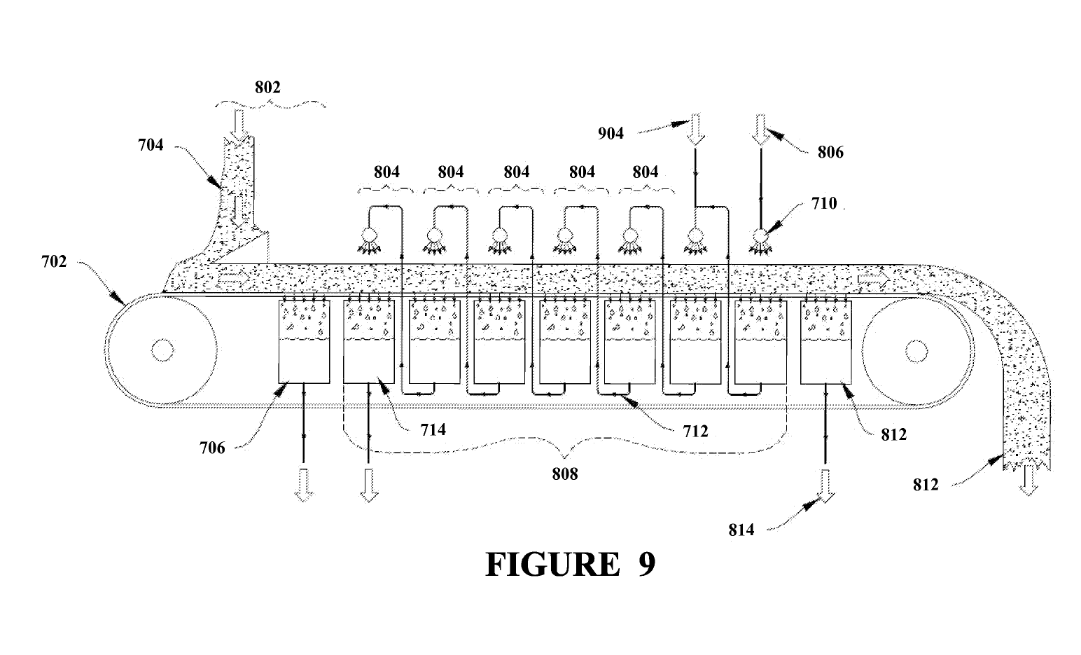

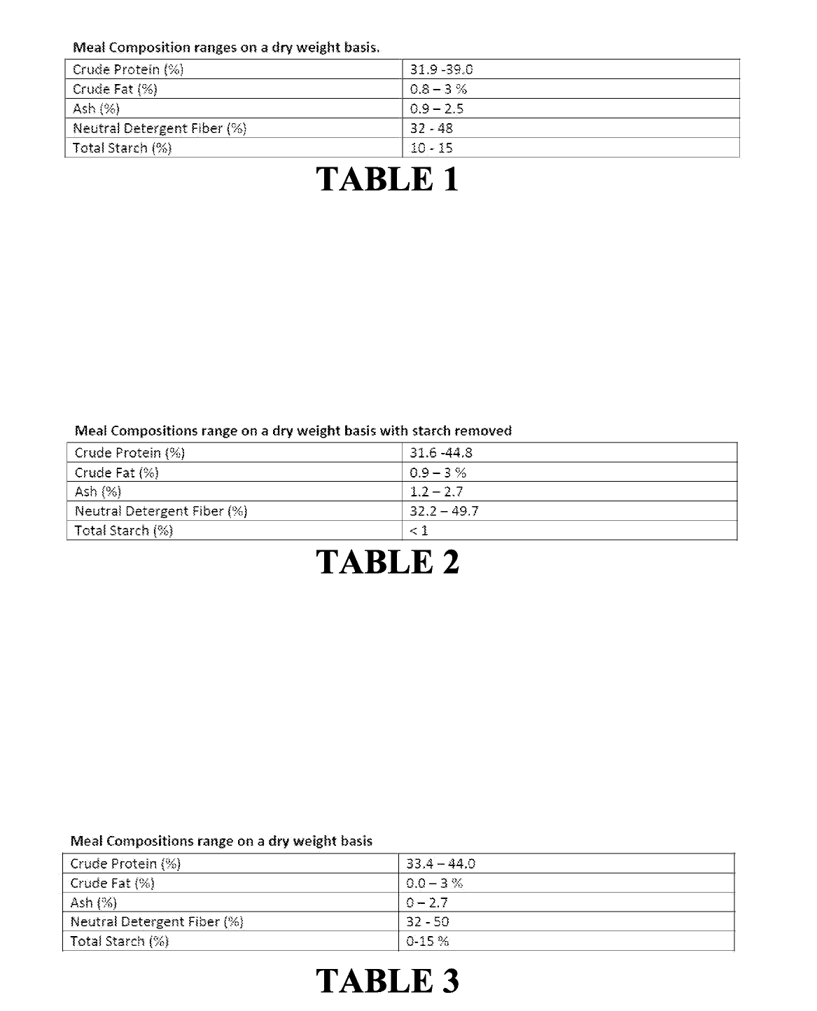

FIG. 9 is a schematic side view of an implementation of a filter belt for the process for producing ethanol. In this view, fermented beer and solids 704 are shown being placed on a filter belt 702. The fermented beer and solids flow along the filter belt, undergoing an initial deliquefaction stage 802, a series of ethanol wash cycles 808, and an evaporation stage 810. At the end of the filter belt 702, corn meal 812 are collected. In some embodiment, the initial ethanol wash 806 may comprise substantially anhydrous ethanol (approximately 100% ethanol). Also in some embodiment, ethanol at a concentration of approximately 95%, or 190 proof (the approximate concentration of ethanol output by the distillation system) may be applied as an ethanol wash 904 prior to the initial wash stage. FIG. 9 shows a countercurrent wash process, such that the liquid component 714 of a downstream wash cycle 804 is used as the ethanol wash 712 for an upstream wash cycle 804. The liquid component 814 from the evaporation stage 810 may be distilled in order to isolate ethanol contained in the liquid 814 or used as a wash in the previous stage. The mother liquor 706 of the initial deliquefaction stage 802 may be used as the initial ethanol wash 806 or as any ethanol wash 712 upstream of the initial ethanol wash 806.

After the ethanol wash stages, the resultant wet solids contain a liquid component with a higher concentration of ethanol than the fermented beer. The resultant wet solids are exposed to an evaporation stage to evaporate the liquid in the wet solids, leaving a dry or substantially dry solid behind. In some embodiments, to minimize the energy needed to create a dry solid from the wet solid, the concentrations of ethanol in the wet solid would be at or above the azeotrope ratio for water and ethanol, which is approximately 96 percent ethanol. At the azeotrope level, ethanol in the wet solids will vaporize at substantially the same concentration as the remaining liquid in the wet solids, leaving a dry solid while using the least amount of energy to effect the evaporation, or drying. With a ratio of water and ethanol below the azeotrope level, drying of wet solids is less efficient than when the ratio is at or above the azeotrope level. If a low amount of water were desired in the resulting solid, or if low concentrations of ethanol were desired in the resulting solid, the concentration of ethanol in the final wet solids could be below the azeotrope ratio for water and ethanol. Vapor recovered in the evaporation stage may be condensed and added to the ethanol wash stream as shown in FIG. 5. In order to effect the condensation of the vapor from the evaporation stage, a heat exchanger could be used to recover waste heat from any available source and direct that heat to the evaporation stage.

In a standard ethanol plant, a dryer is employed in the convention process for drying wet cake derived from the distillation stillage. This exposes DDG to temperatures high enough to vaporize liquid in the DDG. To reduce the exposure of DDG to high temperatures, a large volume of air is commonly injected into the dryer. The DDG is degraded and changes color when exposed to high temperatures. By limiting the temperature that corn meal encounters by using the low energy drying process described in this application, the risk of degradation of the corn meal during the drying process is reduced. Because the wet solids can be dried at much lower temperatures than is required to dry DDG in a conventional process, a large volume of air does not have to be used to aid the drying process.

In a conventional process, vapor exhausted from the dryer contains a very low concentration of liquid, a result of the use of a large volume of air. Because a lower volume of air is used in the process for low energy drying of corn meal, the concentration of liquid in the resulting vapor is higher. In the process for low energy drying, water vapor from the dryer can be condensed and reused. Because the ethanol water vapor can be reused within the plant, the need for releasing that vapor into the environment is eliminated, potentially reducing plant emissions. Because water used in the drying process is recirculated, all of the water initially injected into the fermentation process is sent back to the distillation system, where it can be captured and reused. This significantly reduces the overall water requirements of a plant implementing the present low energy processes.

IV. Corn Meal Compositions

As disclosed above, corn meal is created using a low temperature process. The meal product is not cooked to convert the starch into sugars and does not pass through a distillation system. The final drying step for the meal does not exceed 180° F. in some embodiments, and in some embodiments does not exceed 150° F. Thorough tests conducted on meal products found that as long as the fermentation solids do not see temperatures greater than 150° F. there is no detrimental alteration to their composition (in terms of protein profile, color and chemistry). As temperatures increase, the composition starts changing. With higher the temperature the more change that takes place.

The compositional profile of raw meal, on a dry weight basis is illustrated in Table 1. In these samples, the crude protein level ranges from 31.9-39.0%, fat ranges from 0.8-3%, ash ranges from 0.9-2.5%, detergent fiber ranges from 32-48% and total starch ranges from 10-15%.

The compositions may vary with the change with incoming corn and processing characteristics. The composition can be further modified to remove the starch to less than 1% starch through washing or longer fermentation times, which yields compositions as shown in Table 2. In these “de-starched” samples the crude protein ranges from 31.6-44.8%, fat ranges from 0.9-3%, ash ranges from 1.2-2.7%, detergent fiber ranges from 32.2-49.7% and total starch is less than 1%.

Moisture is added to the dried corn meal product and can vary. Typically the amount of water added varies from 1% to 12% as desired for flow-ability characteristics, end use, and customer specification.

As previously noted the corn meal product can be modified by controlling the amount of protein removed upstream and fines material removed at the initial wash step. The unique desirable range of one example product that may be generated through manipulating protein extraction may be seen in Table 3. In these protein extracted samples the crude protein ranges from 33.4-44.0%, fat ranges from 0.0-3%, ash ranges from 0-2.7%, detergent fiber ranges from 32-50% and total starch ranges from 0-15%.

The embodiments as disclosed and described in the application (including the Figures and Examples) are intended to be illustrative and explanatory. Modifications and variations of the disclosed embodiments, for example, of the apparatus and processes employed (or to be employed) as well as of the compositions and treatments used (or to be used), are possible; all such modifications and variations are intended to be within the scope of the present invention.

What is claimed is:

1. A composition, comprising: a product derived from a wet solids portion of a beer product of a grain-to-ethanol fermentation process, wherein the product comprises a minimally heat-damaged protein in an amount ranging from about 31 to about 45% of the product on a dry weight basis, wherein the minimally heat-damaged protein is protein that has not been exposed to temperatures exceeding about 180° F.

2. A composition according to claim 1, wherein the composition is a corn meal composition.

3. A composition according to claim 2, wherein the minimally heat-damaged protein is a corn protein.

4. A composition according to claim 1, wherein the product further comprises up to about 3% fat on a dry weight basis.

5. A composition according to claim 1, wherein the minimally heat-damaged protein is a protein that has not been exposed to temperatures exceeding about 150° F.

6. A composition according to claim 1, wherein the protein is minimally-heat damaged soybean protein.

7. A composition according to claim 1, wherein the protein comprises protein derived from corn endosperm.

8. A composition according to claim 1, wherein the product further comprises a neutral detergent fiber in an amount ranging from about 32% to about 50% a dry weight basis.

9. A composition according to claim 1, wherein the product further comprises fat in an amount ranging from about 0.8% to about 3% on a dry weight basis.

10. A composition according to claim 1, wherein the product further comprises up to about 15% starch on a dry weight basis.

11. A composition according to claim 1, wherein the product further comprises starch in an amount ranging from about 10% to about 15% on a dry weight basis.

12. A method, comprising:
a. exchanging at least a portion of water in a wet solids product derived from a grain-to-ethanol fermentation beer with a solvent having one of at least a lower heat of vaporization, lower heat capacity, or lower boiling point than water; and,
b. drying the wet solids at a temperature of about 180° F. or less to generate a product comprising a minimally heat-damaged protein in an amount ranging from about 31 to about 45% of the product on a dry weight basis, wherein the minimally heat-damaged protein is protein that has not been exposed to temperatures exceeding about 180° F.

13. A method according to claim 12, wherein the grain is corn and the process further comprises producing a corn meal product.

14. A method according to claim 13, further comprising:
a. fractionating a corn kernel to substantially isolate an endosperm;
b. converting at least some portion of starch in the endosperm to sugar at a temperature of about 180° F. or less;
c. fermenting the sugar to produce a beer; and,
d. obtaining the wet solids portion from the beer.

15. A method according to 12, further comprising extracting a protein from the wet solids prior to solvent exchange.

16. A method according to claim 12, further comprising removing starch from the wet solids.

17. A method according to claim 14, wherein converting the starch to sugar and drying of the solids is performed at about 150 ° F. or less.

18. A method according to claim 12, wherein the solvent is ethanol.

19. A method according to 12, wherein the solvent is a solution of ethanol in water.

20. A method according to 19, wherein the solvent is approximately 95% ethanol.

21. A method according to claim 12, wherein the solvent is chosen to result in a a concentration of ethanol in the wet solids product at or above the azeotrope for water and ethanol.
